(19) United States
(12) Patent Application Publication
(10) Pub. No.: US 2025/0307989 A1
(43) Pub. Date: Oct. 2, 2025

(54) METHOD FOR PROCESSING IMAGE DATA

(71) Applicants: Xavier BAELE, Brussels (BE); Michel SAMUEL, Brussels (BE)

(72) Inventors: Xavier BAELE, Brussels (BE); Michel SAMUEL, Brussels (BE)

(21) Appl. No.: 18/866,748

(22) PCT Filed: May 17, 2023
(86) PCT No.: PCT/EP2023/063272

§ 371 Date: Nov. 18, 2024

(30) Foreign Application Priority Data
May 18, 2022 (EP) 22174196.0

(51) Int. Cl. G06T 5/20; G06T 5/70

(52) U.S. Cl. CPC G06T 5/20; G06T 5/70; G06T 2207/20064

(57) ABSTRACT

A computer-implemented method for processing image data representing at least one image, wherein said image data includes at least one input pixel array, wherein a pixel value is associated to each pixel of the at least one input pixel array, the method comprising the steps of recursively performing a hierarchal multiscale decomposition of the image data into a multilevel hierarchy of pixel arrays, wherein per scale level of the multilevel hierarchy, the at least one input pixel array is decomposed into a low frequency pixel array and at least one high frequency pixel array.

### FIELD OF THE INVENTION

The present invention generally relates to a method for processing image data, in particular to a method for denoising and/or deflickering image data, in particular low light image data.

### BACKGROUND OF THE INVENTION

Digital images are inevitably degraded by noise, i.e. artefacts that do not originate from the original scene content, which can deteriorate the visual quality of the images, in particular in low light images. In a series of images, such as in video images, global light changes between frames can lead to flickering images. The problem of noise and flickering reduction in images has been known and studied for a long time but is rather complex since noise reduction methods can also lead to losing image quality, for example loss of sharpness of edges, known as blurring, and/or introduction of artefacts.

Many different filtering methods exist, such as for example mean filtering or Wiener filtering, which are all spatial domain linear filtering methods. Another example is bilateral filtering, which is a relatively widely used as image denoising method. It is a non-linear method which has the advantage of preserving edges relatively well. In this method, an intensity value of each pixel is replaced with a weighted average of intensity values of nearby pixels.

A problem linked to these methods is that the known methods require quite some processing and/or calculation power, which is a problem in particular for relatively large images. Due to the required power, such methods may therefore be relatively slow, in particular for video images.

It is therefore an aim of the present invention to solve or at least alleviate one or more of the above-mentioned problems. In particular, the invention aims at providing an improved method for denoising and/or deflickering image data which is relatively fast while remaining efficient.

### SUMMARY OF THE INVENTION

To this aim, there is provided a computer-implemented method for processing image data characterized by the features of claim 1. In particular, the image data represent at least one image, so either a single image or a temporal sequence of images, such as in video images. The image data can for example comprise low light image data. Said image data includes at least one input pixel array. A single image can be represented by a single input pixel array and a sequence of images can be represented by a temporal sequence of pixel arrays. A pixel value is associated to each pixel of the at least one input pixel array. The pixel value may be a mono dimensional pixel value representing for example a light intensity or depth of said pixel in the image. Alternatively, the pixel value may be a multi-dimensional pixel value, such as an intensity in RGB of said pixel in the image. The method for processing said image data comprises the steps of recursively performing a hierarchal multiscale decomposition of the image data into a multilevel hierarchy of pixel arrays, such that per scale level of the multilevel hierarchy, the at least one input pixel array is decomposed into a low frequency pixel array and at least one high frequency pixel array. The hierarchal multiscale decomposition may include a wavelet decomposition, for example a Haar wavelet decomposition, or a pyramid decomposition or any other suitable multiscale decomposition including performing a discrete spectral transform. The recursiveness of the performing of the multiscale decomposition preferably only applies to the low frequency pixel array, as is known to the person skilled in the art: only the low frequency pixel array of a first scale level is preferably further decomposed into a low frequency pixel array and at least one high frequency pixel array of a next scale level.

The method further comprises the step of, per scale level of the multilevel hierarchy of pixel arrays, forming a first cluster of pixel arrays of said scale level by selecting a plurality of said low frequency pixel arrays and/or said high frequency pixel arrays, in particular either a plurality of said low frequency pixel arrays of said scale level of the multilevel hierarchy of a temporal sequence of input pixel arrays, or the low frequency pixel array and the at least one high frequency pixel array of said scale level of the multilevel hierarchy of the at least one input pixel array. Said first cluster of pixel arrays can allow a grouped processing of the selected pixel arrays. The selection of the pixel arrays to form said first cluster may depend on a type of desired processing: denoising image data and/or deflickering image data.

The method further comprises the step of, per scale level of the multilevel hierarchy, performing a first edge preserving convolution to the low frequency pixel array of said scale level of said multilevel hierarchy of pixel arrays. In an inventive way, said first edge preserving convolution uses a weighted filtering wherein a weight of the filtering for a pixel of said low frequency pixel array is dependent on a difference or distance between the pixel values associated to said pixel in each of the pixel arrays of said first cluster of pixel arrays of said scale level simultaneously or jointly, meaning that corresponding pixel values in each of the pixel arrays of said first cluster are jointly taken into account for grouped processing. The distance between the pixel values is to be understood as a mathematical distance, for example, but not necessarily only, as a Euclidean distance. The dependency on said distance may for example include a function such that the weight decreases with increasing distance. Alternatively, any other functional dependence may be used. The dependency may for example include an increasing weight for an increasing distance combined with a decreasing weight with an increasing distance from a threshold distance on. Compared to conventional bilateral filtering, this innovative weighted filtering uses a weight based on a plurality of pixel arrays that relate in space, time and throughout the hierarchal decomposition into low and high frequency pixel arrays simultaneously, meaning jointly. A weight in a conventional bilateral filtering only takes into account spatial closeness and an intensity difference of nearby pixels in the image or in its associated pixel array itself.

The method finally comprises the step of recomposing an output pixel array by recursively performing an inverse transform of the hierarchal multiscale decomposition on the filtered low frequency pixel array and the high frequency pixel arrays. As a result, the output pixel array can provide denoised and/or deflickered image data. Since the method relies on a perspicacious combination of an efficient hierarchal image decomposition and an innovative weighted filtering, the method is relatively fast and needs fewer calculation and processing time and/or capacity than known methods, which is in particular advantageous for low light image data, more in particular for low light video image data.

The first cluster of pixel arrays can advantageously be formed by selecting the low frequency pixel arrays of said scale level of the multilevel hierarchy of said temporal sequence of input pixel arrays. A temporal sequence of input pixel arrays can apply in particular in the case of image data including video image data, wherein a relatively high number of image frames are taken in a temporal sequence, for example at various times t in a time window [tₘᵢₙ, tₘₐₓ] around a reference time t₀. Each image frame of such a temporal sequence can be represented by an input pixel array I(x,y,t), thus forming a temporal sequence of input pixel arrays. Each input pixel array of said sequence of input pixel arrays is then decomposed into a low frequency pixel array C_{LF}(x,y,t) and at least one high frequency pixel array C_{HF}(x,y,t) in a recursive and multiscale hierarchal way. The selection step to form a first cluster, performed per scale level, can then include the low frequency pixel arrays of said scale level, for example at various times t in the time window [tₘᵢₙ, tₘₐₓ] around a reference time t₀.

The weight w of the filtering for a pixel of said low frequency pixel array of the temporal sequence of input pixel arrays at times t in a time window [tₘᵢₙ, tₘₐₓ] around reference time t₀ is then for example given by:

$$w ( x , y , t ) = exp ( - \frac{\vert {C}_{LF} ( x , y , t ) - {C}_{LF} ( x , y , {t}_{0} ) \vert}{2 {σ}_{t}^{2}} )$$

where σₜ is a parameter linked to flicker and/or noise amplitude. The absolute value |C_{LF}(x, y, t)−C_{LF}(x, y, t₀)| is the distance on which the weight is dependent. The negative exponential function has the effect that the weight decreases when the distance |C_{LF}(x, y, t)−C_{LF}(x, y, t₀)| increases. Other functions can be used as well depending on the desired dependency and effect. Since the selection step and the filtering is applied per scale level of the multilevel hierarchy, this weight can vary per scale level. This weight can then be taken into account when performing the first edge preserving convolution, which then results in a filtered low frequency pixel array C′_{LF}:

$${C}_{LF}^{′} = \frac{{\sum }_{t ∈ [ {t}_{min} , {t}_{max} ]} w ( x , y , t ) \cdot {C}_{LF} ( x , y , t )}{{\sum }_{t ∈ [ {t}_{min} , {t}_{max} ]} w ( x , y , t )}$$

where [tₘᵢₙ, tₘₐₓ] is a time window in which the filtering is applied. This time window can vary according to the scale level of the multilevel hierarchy to which the first edge preserving deconvolution is performed. In particular, the time window can be larger for higher scale levels of the multiscale decomposition since the resolution is lower at said higher scale levels. Filtering image data including a temporal sequence of image frames using the above-described method with the above-mentioned filtering weight can provide output pixel arrays representing filtered image data in which flickering between frames of said temporal sequence of image frames has been minimized in an efficient way.

Alternatively, said first cluster of pixel arrays can be formed by selecting the low frequency pixel array and the at least one high frequency pixel array of said scale level of the multilevel hierarchy of the at least one input pixel array. An input pixel array I(x,y) is decomposed into a low frequency pixel array C_{LF}(x,y) and at least one, and preferably a plurality of, high frequency pixel arrays C_{HF}(x,y) in a recursive and multiscale hierarchal way. For a sequence of input pixel arrays at times t in a time window [tₘᵢₙ, tₘₐₓ], the hierarchal multiscale decomposition may be performed per time. The selection step to form a first cluster, performed per scale level and per time, can then include the low frequency pixel array of said scale level at time t as well as all the high frequency pixel arrays of said level at time t. Such a selection into a first cluster of pixel arrays may be particularly efficient for denoising images.

The weight of the filtering is then preferably dependent on a distance between the pixel values associated to a pixel in a neighbourhood around said pixel. Said neighbourhood may have a same size in the low frequency pixel array as well as in the at least one high frequency pixel arrays of said scale level. The size of the neighbourhood may be determined as a compromise between calculation time and image quality improvement.

The weight W(i,j) of the filtering for a pixel of said low frequency pixel array C_{LF}(x,y) can for example be given by:

$$W ( i , j ) = exp ( - \frac{{D ( i , j )}^{2}}{2 {σ}_{l}^{2}} )$$

where D is the multidimensional Euclidean distance given by:

$$D ( i , j ) = \sqrt{{( {C}_{LF} ( x + i , y + j ) - {C}_{LF} ( x , y ) )}^{2} + {\sum }_{k} {( {C}_{HF}^{k} ( x + i , y + j ) - {C}_{HF}^{k} ( x , y ) )}^{2}} ,$$

where k is the index of the high frequency pixel arrays of the scale level for which the filtering is performed and (x+i,y+j) indicates a neighbouring pixel around pixel (x,y). Again, the negative exponential function has the effect that the weight decreases when the distance D increases, but other functions can be used as well depending on the desired dependency and effect. With the given weight, the performance of an edge preserving convolution to the low frequency pixel array of said scale level can result in a filtered low frequency pixel array C′_{LF}:

$${C}_{LF}^{′} ( x , y ) = \frac{{\sum }_{i , j} W ( i , j ) \cdot {C}_{LF} ( x + i , y + j )}{{\sum }_{i , j} W ( i , j )} .$$

When the first cluster of pixel arrays includes the low frequency pixel array and the at least one high frequency pixel array of said scale level, the method may then further comprise the step of, per scale level of the multilevel hierarchy, performing an edge preserving convolution to the at least one high frequency pixel array of said scale level of said multilevel hierarchy of pixel arrays using a weighted filtering. A weight of the filtering for a pixel of said at least one high frequency pixel array is then dependent on a distance between the pixel values associated to said pixel in each of the pixel arrays of said first cluster of pixel arrays of said scale level simultaneously, meaning jointly. In that case, the performance of an edge preserving convolution to the at least one high frequency pixel array of said scale level can result in at least one filtered high frequency pixel array C′_{HF}:

$${C}_{HF}^{k} ( x , y ) = \frac{{\sum }_{i , j} W ( i , j ) \cdot {C}_{HF}^{k} ( x + i , y + j )}{{\sum }_{i , j} W ( i , j )}$$

where σₗ is a parameter depending on scale level l such that σₗ=α^{l}·σ and in which σ is dependent on an average noise amplitude and in which α is a constant, for example α≈0.48.

When edge preserving convolution is also performed to the at least one high frequency pixel array, then the step of recomposing the output pixel array I′(x,y) is done by recursively performing an inverse transform of the hierarchal multiscale decomposition on the filtered low frequency pixel array C′_{LF}(x, y) and the filtered high frequency pixel arrays C_{HF}^{k′}(x, y). Filtering image data using the above-described method with the above-mentioned filtering weight can provide an output pixel array representing filtered image data in which noise within said image data has been minimized in an efficient way. The efficiency, in particular the reduction in calculation time and required calculation power, is at least partly due to the fact that the weights used in the filtering are based directly on the multiscale decomposition into a low frequency pixel array and at least one high frequency pixel array, thus reducing the number of operations to be performed.

It may further be preferred that the filtering includes at least one factor configured to adjust a weight of each of the low frequency pixel array and the at least one high frequency pixel array of the first cluster. Such a factor may be a constant weight and depend on noise level and on the type of multiscale decomposition. The factor may be a factor K_{LF} specific for the filtering of the low frequency pixel array and a factor K_{HF} for the at least one high frequency pixel array.

The method can advantageously further comprise a step of forming a second cluster of pixel arrays of said scale level by selecting said low frequency pixel arrays of said scale level of the multilevel hierarchy of a temporal sequence of input pixel arrays, and a step of performing a second edge preserving convolution step on the filtered low frequency pixel array. In this way, different selections can be performed with different purposes, for example a first selection step forming a first cluster for a first type of image processing and a second selection step forming a second cluster, which may differ from the first cluster, for a second type of image processing.

Said first cluster of pixel arrays can for example include the low frequency pixel array and the at least one high frequency pixel array of said scale level of the multilevel hierarchy of the at least one input pixel array, preferably of a temporal sequence of input pixel arrays, while the second cluster of pixel arrays can include the low frequency pixel arrays of said scale level of the multilevel hierarchy of said temporal sequence of input pixel arrays. The first cluster of pixel arrays and the second cluster of pixel arrays may at least partly include the same pixel arrays. In particular, a low frequency pixel array of a given scale level may be part of the first cluster and of the second cluster. In this way, the low frequency pixel array can undergo two edge preserving convolutions with different weights.

In this preferred embodiment of the method, the first edge preserving convolution may be performed to the low frequency pixel array and to the at least one high frequency pixel array of said scale level of said multilevel hierarchy of pixel arrays, as described above. In particular, the edge preserving convolution uses a weighted filtering wherein a weight of the filtering for a pixel, of the low frequency pixel array or of the at least one high frequency pixel array, is dependent on a distance between the pixel values associated to said pixel in each of the pixel arrays of said first cluster of pixel arrays of said scale level simultaneously, meaning jointly. In particular, the weight can for example take into account neighbouring pixels in both the low frequency and the high frequency pixel arrays of a given scale level at a given point in time. The second edge preserving convolution may then be performed on the filtered low frequency pixel array of said scale level of said multilevel hierarchy of pixel arrays using a weighted filtering wherein a weight of the filtering for a pixel is dependent on a distance between the pixel values associated to said pixel in each of the pixel arrays of said second cluster of pixel arrays of said scale level simultaneously, meaning jointly. In particular, the weight can take into account pixel values of a temporal sequence of pixel arrays in a predetermined time range around time t₀. Also taking into account neighbouring pixels in the weight for the second edge preserving convolution is possible but can increase calculation time without equally increasing image quality. The step of recomposing the output pixel array may then be done by recursively performing an inverse transform of the hierarchal multiscale decomposition on the low frequency pixel array filtered by the second edge preserving convolution and the high frequency pixel arrays filtered by the first edge preserving convolution. Performing in this way a first and a second cluster forming step, as well as a first and a second edge preserving deconvolution, can allow to first denoise image data, in particular on individual images, before reducing flickering between image data in a temporal sequence of images.

The method may further comprise a step of postprocessing the image data, in particular, of the recomposed output pixel array. This step may preferably include performing a weighted filtering of the recomposed output pixel array wherein a weight of said filtering for a pixel of said recomposed output pixel array is dependent on a difference between the pixel value associated to said pixel and a local average. The choice for such a postprocessing step may depend on the hierarchal multiscale decomposition. Some decompositions may result in multiscale induced artefacts, such the Gibbs phenomenon, which then may need correction in a postprocessing step. This step of postprocessing of the image data may preferably be performed according to a computer-implemented method for postprocessing image data, which may be considered as an invention of its own. Said image data is represented as an image pixel array, wherein a value is associated to each pixel of the image pixel array. The method comprises the steps of determining an average pixel array by convoluting the image pixel array, for example the output pixel array I′(x,y) of a method as previously described, with an averaging kernel. Said average kernel may for example be a Gaussian blur 3×3 kernel such as

$$M = \frac{1}{16} [ \begin{matrix}1 & 2 & 1 \\ 2 & 4 & 2 \\ 1 & 2 & 1\end{matrix} ]$$

or any other known average kernel. The method further comprises the step of determining a difference δ of a neighbourhood in the image pixel array, for example in I′(x+i,y+j), and the average pixel array μ(x,y). The method further comprises the step of determining a weighted filter result for said difference δ. The method for postprocessing image data finally includes the step of adding the weighted filter result to the average pixel array μ(x,y), thereby obtaining postprocessed image data Iᵣₑₛ(x,y). As an example, a weighted filter may be applied to the recomposed output pixel array I′(x,y) such that the postprocessed pixel array may be represented as:

$${I}_{res} = ( x , y ) = μ ( x , y ) + \frac{{\sum }_{i , j} exp ( - \frac{{δ ( x + i , y + j )}^{2}}{2 {σ}^{2}} ) δ ( x + i , y + j )}{{\sum }_{i , j} exp ( - \frac{{δ ( x + i , y + j )}^{2}}{2 {σ}^{2}} )}$$

where σ is a parameter depending on the multiscale decomposition, in particular on the type of decomposition as well as on the number of scale levels, and δ(x+i, y+j)=I′(x,y)−μ(x,y) with (x,y) being the local average obtained by convoluting I′(x,y) with an average kernel, for example

$$M = \frac{1}{16} [ \begin{matrix}1 & 2 & 1 \\ 2 & 4 & 2 \\ 1 & 2 & 1\end{matrix} ] .$$

The method can further comprise a step of prefiltering the image data. Prefiltering the image data may include normalizing levels of the image data and/or removing statistical outliers among the pixels of the image data, for example due to dead, burned or locked pixels. This step of prefiltering image data may be performed using any known prefiltering method.

Alternatively, and preferably, the prefiltering of the image data may be performed according to a computer-implemented method for prefiltering image data, which may be considered as an invention of its own. Said image data is represented as an image pixel array, wherein a value is associated to each pixel of the image pixel array. The method comprises the steps of determining an average pixel array by convoluting the image pixel array with an averaging kernel. Said average kernel may for example be a Gaussian blur 3×3 kernel such as

$$M = \frac{1}{16} [ \begin{matrix}1 & 2 & 1 \\ 2 & 4 & 2 \\ 1 & 2 & 1\end{matrix} ]$$

or any other known average kernel. The method further comprises the step of determining a variation pixel array v by convoluting a difference of the image data and the average pixel array μ(x,y) in absolute value |I(x, y)−μ(x, y)| with an averaging kernel, like for example the above-mentioned matrix M. The method then comprises the step of determining a modified difference δ′ of the difference δ of the image data and the average pixel array, so δ=I(x, y)−μ(x, y). Said modified difference δ′ includes an exponential function of said difference depending on said variation pixel array, such that the modified difference includes reduced values with respect to the difference for values outside of a distribution determined by the average pixel array and the variation pixel array. The method for prefiltering image data finally includes the step of adding the modified difference δ′ to the average pixel array μ(x,y), thereby bringing back the noise into normalized statistics and obtaining prefiltered image data I′(x,y).

Said modified difference δ′ may preferably include a linear response for values within the distribution determined by the average pixel array and the variation pixel array such that central pixel values can remain unmodified.

Said modified difference δ′ may include a response factor ρ configured to be tuned such that the modified difference includes reduced values, respectively amplified values, with respect to the difference for values within the distribution determined by the average pixel array and the variation pixel array. In particular, the response factor ρ may be chosen such that
a linear response with respect to δ is obtained under local variation v when ρ=1;
a reduced response with respect to δ is obtained under local variation v when ρ<1;
an amplified response with respect to δ is obtained under local variation v when ρ>1.

Said modified difference δ′ may advantageously be given by:

$${δ}^{′} = \frac{δ}{N} \cdot exp ( \frac{- {δ}^{2}}{2 {v}^{2}} ) \cdot exp ( - \frac{\vert {δ}^{2} - {v}^{2} \vert}{2 ρ {v}^{2}} )$$

where N is a constant:

$$N = exp ( - \frac{1}{2} )$$

and ρ is the response factor as previously described. Said modified difference is a function of the difference δ including two exponential functions. The interaction between said two exponential functions allows to describe in a single function a behaviour which is different within and outside the distribution determined by the average pixel array and the variation pixel array. Without said modified function, a similar behaviour would be described and programmed with a plurality of different functions depending on a domain, or in programming terms, with loops and conditional functions on the domain. Said modified difference can avoid such loops and conditional functions and can simplify and speed up calculation, such that the prefiltering of the image data can be accelerated without losing image quality.

The above-described computer-implemented method for prefiltering image data may be used independently on image data from the method for processing image data as described before. However, the prefiltering method may also be advantageously integrated into the method for processing image data, either as a separate prefiltering step before the recursive performance of a hierarchal multiscale decomposition of the image data, or as part of the one or more edge preserving deconvolutions in the processing method.

According to further aspects of the invention, there is provided a controller, a computer program product and a computer readable storage medium for performing the above-described method, having the features of claims 12, 13 and 14 respectively, thus providing one or more of the previously mentioned advantages.

### BRIEF DESCRIPTION OF THE DRAWINGS

FIG. 1 shows a schematic flow diagram illustrating a preferred embodiment of the computer-implemented method for processing image data according to an aspect of the invention;

FIG. 2 shows a series of graphs representing an effect of a preferred embodiment of the computer-implemented method for prefiltering image data according to a further aspect of the invention;

FIG. 3 shows a schematic graph illustrating step 110 of the method shown in FIG. 1;

FIGS. 4a and 4b show a schematic graph illustrating step 120, respectively step140, of the method shown in FIG. 1;

FIG. 5 shows a schematic graph illustrating step 160 of the method shown in FIG. 1; and

FIG. 6 shows a computing system suitable for performing various steps of the method according to example embodiments.

### DETAILED DESCRIPTION OF EMBODIMENT(S)

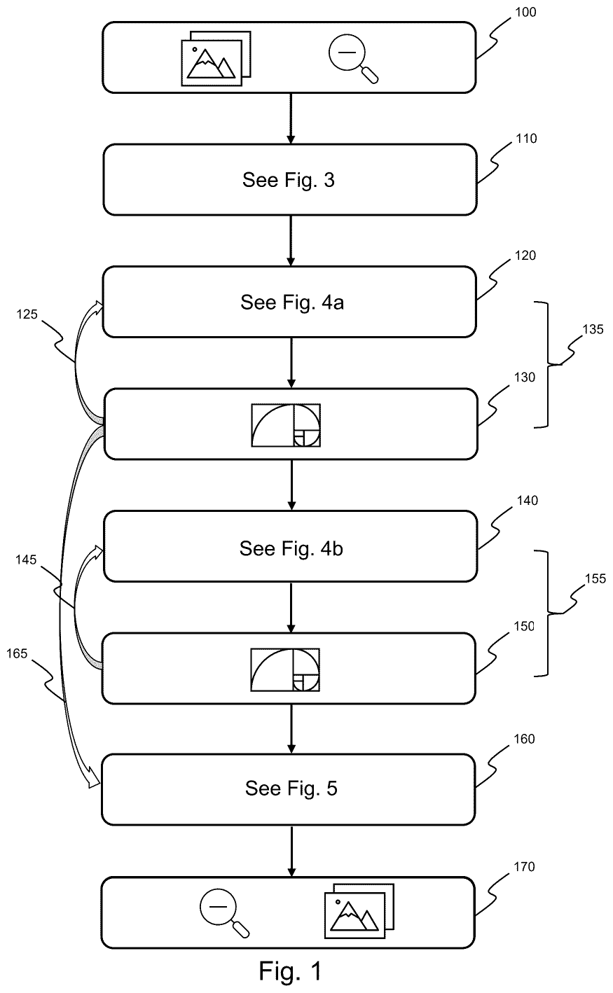

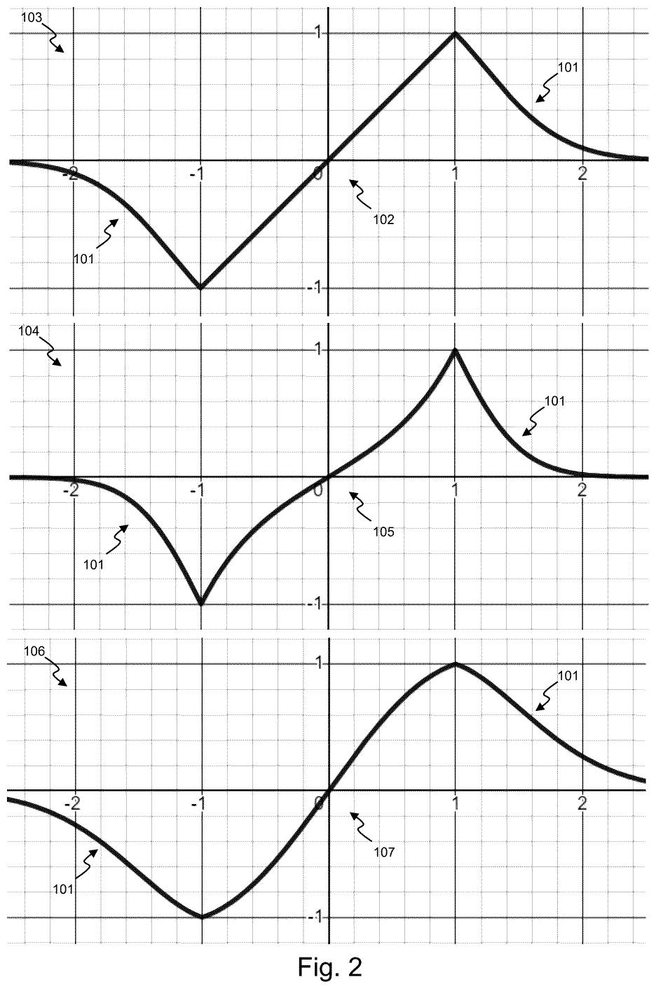

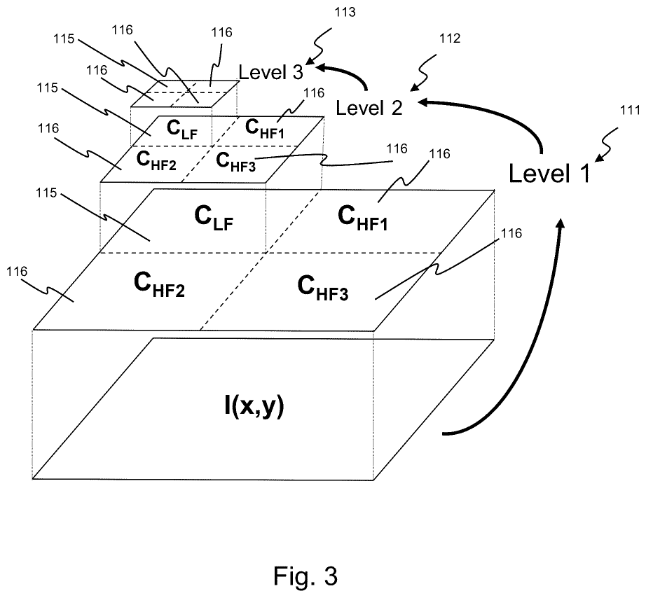

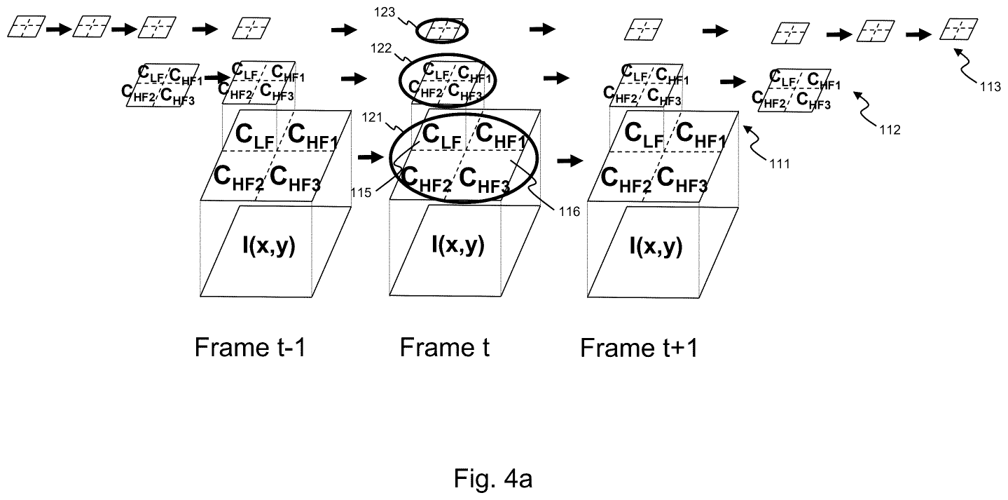

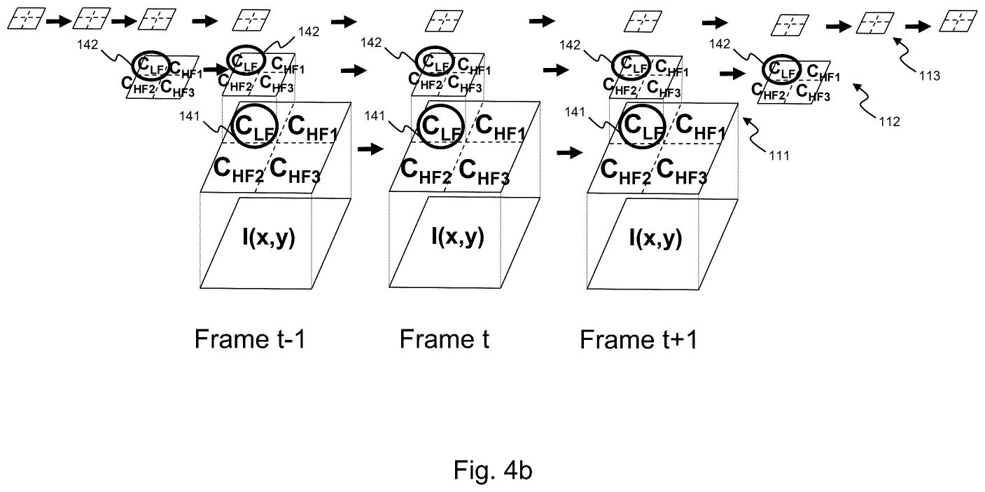

FIG. 1 shows a schematic flow diagram illustrating a preferred embodiment of the computer-implemented method for processing image data according to an aspect of the invention. After having acquired image data, for example an image frame, or more preferably, a plurality of image frames, for example a temporal sequence of image frames, such as in video image data, an optional step of pre-filtering 100 can be carried out. An image frame can be represented by a pixel array, and a temporal sequence of image frames can be represented as a temporal sequence of pixel arrays. In said one or more pixel arrays, a mono-dimensional or multi-dimensional value can be associated to each pixel, representing for example an intensity, depth or RGB value of that pixel. Prefiltering image data 100 can allow to normalize shape and levels of image data and to remove statistical outliers, for example due to dead, burned or locked pixels. This pre-filtering can be done by any method known to the person skilled in the art. More preferably, a novel computer-implemented method for prefiltering image data, which may be considered as an invention on its own, may be applied, which will be explained in more detail with reference to FIG. 2. In a next step 110, the input pixel arrays are decomposed recursively into a multilevel hierarchy of pixel arrays, such that per scale level of the multilevel hierarchy, the at least one input pixel array is decomposed into a low frequency pixel array and at least one high frequency pixel array, which will be explained in more detail with reference to FIG. 3. Steps 120, 130, 140 and 150 will be explained in more detail with reference to FIGS. 4a and 4b. These steps deal with a selection or cluster forming step 120, 140 to form a first and a second cluster of pixel arrays followed by an edge preserving deconvolution 130, 150 including a weight taking into account the pixel arrays of said first or second cluster. These steps are repeated 125, 145 and performed per scale level of the multilevel decomposition. In the first processing part 135, the at least one pixel array may be denoised, whereas in the second processing part 155, flickering between image frames in a temporal sequence of image frames may be reduced. In step 160, at least one output pixel array is recomposed by recursively performing an inverse transform of the hierarchal multiscale decomposition on the filtered pixel arrays of steps 130 (165) and 150. Finally, and optionally, the at least one output pixel array of step 160 may be post-processed 170 in case there are multiscale induced artefacts in the recomposed image, such as for example Gibbs artefacts. Some of these steps may be performed simultaneously with other steps and/or an order of steps may be inversed. As an example, prefiltering image data may also be done after a hierarchal multilevel decomposition.

FIG. 2 shows a series of graphs representing an effect of a preferred embodiment of the computer-implemented method for prefiltering image data according to a further aspect of the invention. According to this method, an average pixel array μ(x,y) is determined by convoluting the input image pixel array I(x, y) with an averaging kernel M. Then a variation pixel array v is determined by convoluting a difference δ of the input image pixel array and the average pixel array in absolute value |I(x, y)−μ(x, y)| with an averaging kernel, like for example the above-mentioned matrix M. In an inventive way, a modified difference δ′ of the difference δ of the image data and the average pixel array, so of δ=I(x, y)−μ(x, y) is determined. Said modified difference δ′ includes an exponential function of said difference depending on said variation pixel array, such that the modified difference includes reduced values 101 with respect to the difference for values outside of a distribution determined by the average pixel array and the variation pixel array. Instead of adding the difference δ to the average pixel array, the modified difference δ′ is added to the average pixel array μ(x,y), thereby bringing back the noise into normalized statistics and obtaining a prefiltered image frame. Said modified difference δ′ may preferably be chosen such as to include a linear response 102 for values within the distribution determined by the average pixel array and the variation pixel array. More preferably, the modified difference δ′ may include a response factor ρ configured to be tuned such that the modified difference includes reduced values, respectively amplified values, with respect to the difference for values within the distribution determined by the average pixel array and the variation pixel array. In particular, in FIG. 2, the graphs 103, 104, 106 represent the modified difference δ′ in function of the unmodified difference δ for a variance v=1. In the upper graph 103, the response factor is ρ=1 such that there is a linear response 102 with respect to δ for values within the distribution determined by the average pixel array and the variation pixel array and reduced values 101 with respect to the difference for values outside of the distribution determined by the average pixel array and the variation pixel array. In the middle graph 104, the response factor is ρ<1 such that there is a reduced response 105 with respect to δ for values within the distribution determined by the average pixel array and the variation pixel array and reduced values 101 with respect to the difference for values outside of the distribution determined by the average pixel array and the variation pixel array. In the lower graph 106, the response factor is ρ>1 such that there is an amplified response 107 with respect to δ for values within the distribution determined by the average pixel array and the variation pixel array and reduced values 101 with respect to the difference for values outside of the distribution determined by the average pixel array and the variation pixel array.

FIG. 3 shows a schematic graph illustrating step 110 of the method shown in FIG. 1. In step 110, a multilevel hierarchy decomposition of pixel arrays is performed to every image frame, represented as an input pixel array I(x,y). This means that per scale level 111, 112, 113 of the multilevel hierarchy, an input pixel array is decomposed into a low frequency pixel array 115 and at least one high frequency pixel array 116. This is done in a recursive way on the low frequency pixel arrays 115, i.e. a low frequency pixel array 115 of a first level 111 may be further decomposed in a low frequency array 115 and one or more high frequency pixel arrays 116 of a next level 112. Again, the low frequency pixel array 115 of the second level 112 may be further decomposed into a low frequency pixel array 115 and one or more high frequency pixel arrays 116 of a third level 113. This hierarchal multiscale decomposition may include a wavelet decomposition, for example a Haar wavelet decomposition, or a pyramid decomposition or any other suitable multiscale decomposition including performing a discrete spectral transform on the input pixel array and the low frequency pixel arrays.

FIGS. 4a and 4b show a schematic graph illustrating step 120, respectively step 140, of the method shown in FIG. 1. Step 120, shown in FIG. 4a, is performed per scale level 111, 112, 113 separately and includes selecting a plurality of said low frequency pixel arrays and/or said high frequency pixel arrays of a respective scale level to form a first cluster of pixel arrays of said scale level. Said first cluster 121, 122, 123 of pixel arrays can preferably include the low frequency pixel array 115 and the at least one high frequency pixel array 116 of the respective scale level 111, 112, 113 of the multilevel hierarchy. In case of a temporal sequence of image frames included in a time window [tₘᵢₙ, tₘₐₓ], for example frames taken at time t−1, t and t+1, where t is the reference time, this selection step 120 is not only done per scale level but also per frame in time, just like the hierarchal multilevel decomposition is done separately per frame in time. In a next step 130, a first edge preserving convolution is performed to the low frequency pixel array 115 and to the at least one high frequency pixel array 116 of the respective scale level 111, 112 of said multilevel hierarchy of pixel arrays using a weighted filtering. The weight of the filtering for a pixel is dependent on a distance between the pixel values associated to said pixel in each of the pixel arrays of said first cluster of pixel arrays of said scale level simultaneously, meaning jointly. As a result, pixel values of both the high frequency pixel arrays and the low frequency pixel array of the first cluster of a respective scale level are taken into account simultaneously, meaning jointly. The weight of the filtering may further be dependent on a difference between the pixel values associated to a pixel in a neighbourhood around said pixel. The filtering may also include at least one factor configured to adjust a weight of each of the low frequency pixel array and the at least one high frequency pixel array of the first cluster. Such a factor may be a constant weight and depend on noise level and on the type of multiscale decomposition. The factor may be a factor K_{LF} specific for the filtering of the low frequency pixel array and a factor K_{HF} for the at least one high frequency pixel array. This first edge preserving convolution 130 can thus result in a filtered low frequency pixel array C′_{LF} and at least one filtered high frequency pixel array C′_{HF} per scale level. Steps 120 and 130 may thus be repeated 125 per scale level. This first selection of pixel arrays into a first cluster and the associated first edge preserving convolution can be regarded as an image denoising step 135.

In a next step 140, illustrated in FIG. 4b, a plurality of pixel arrays is selected to form a second cluster 141, 142. The second cluster of pixel arrays can include the low frequency pixel arrays of a scale level 111, 112, 113 of the multilevel hierarchy of a temporal sequence of input pixel arrays. The time window for this second cluster 141, 142 may vary depending on the scale level 111, 112, 113: the further the decomposition scale level, the larger the time window may be chosen for this second cluster 141, 142. As an example, at scale level 111, the second cluster 141 may include the low frequency pixel arrays of t−1, t and t+1, whereas at scale level 112, the second cluster 142 may include additional low frequency pixel arrays of earlier and/or later times. At scale level 113, still more low frequency pixel arrays may be included in the second cluster (not shown) of said level. In a next step 150, a second edge preserving convolution is performed on the filtered low frequency pixel array 115 at time t of the respective scale level 111, 112, 113 of said multilevel hierarchy of pixel arrays using a weighted filtering. The weight of the filtering for a pixel is dependent on a distance between the pixel values associated to said pixel in each of the pixel arrays of said second cluster of pixel arrays 141, 142 of the respective scale level 111, 112, 113 simultaneously, meaning jointly. Pixel values in a neighbourhood around said pixel are preferably not taken into account in the weight, since it does not seem to substantially impact on image quality. As can be seen in FIGS. 4a and 4b, the first cluster 121 and the second cluster 141 can include at least partly the same pixel arrays, in particular the low frequency pixel array of the respective level of the frame at time t. As a result, the second edge preserving convolution may be performed on the filtered low frequency pixel array C′_{LF} which is the outcome of step image 130. The second edge preserving convolution 150 can thus result in the double filtered low frequency pixel array C″_{LF} per scale level. The selection step 140 and the deconvolution step 150 can again be repeated 145 per scale level, which may be done simultaneously or sequentially with respect to step 125. This second selection of pixel arrays forming a second cluster and the associated second edge preserving convolution can be regarded as an image deflickering step 155.

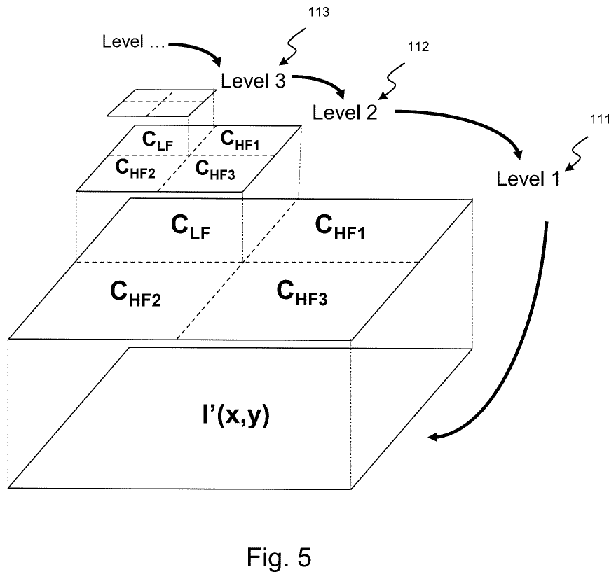

FIG. 5 shows a schematic graph illustrating step 160 of the method shown in FIG. 1. In this step 160, the output pixel array I′(x,y) is recomposed, which is done by recursively performing an inverse transform of the hierarchal multiscale decomposition on the low frequency pixel array C″_{LF} filtered by the second edge preserving convolution 150 and the high frequency pixel arrays C′_{HF} filtered by the first edge preserving convolution 130. Said high frequency pixel arrays have not been selected to form the second cluster and have not been taken into account in the second edge preserving convolution, so they go from step 130 directly via arrow 165 to step 160. As previously explained, the low frequency pixel array may preferably have been filtered twice: first by the first edge preserving convolution and then by the second edge preserving convolution. The recursiveness of this step 160 is again performed on the low frequency pixel array only. In particular, starting from the highest scale level, for example scale level 113, the filtered low frequency pixel array and the at least one high frequency pixel arrays of said level 113 are recomposed into a low frequency pixel array of a lower scale level, in particular of scale level 112, where said low frequency pixel array and the at least one high frequency pixel arrays of scale level 112 can be recomposed into the low frequency pixel array of scale level 111. The above-described method thus allows to obtain final processed image data in which noise and flickering is substantially reduced without reasonably losing image details or without substantially increasing image blurring.

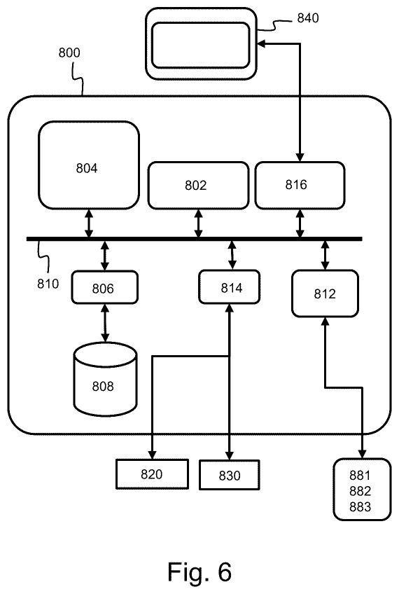

FIG. 6 shows a suitable computing system 800 comprising circuitry enabling the performance of steps according to the described embodiments. Computing system 800 may in general be formed as a suitable general-purpose computer and comprise a bus 810, a processor 802, a local memory 804, one or more optional input interfaces 814, one or more optional output interfaces 816, a communication interface 812, a storage element interface 806, and one or more storage elements 808. Bus 810 may comprise one or more conductors that permit communication among the components of the computing system 800. Processor 802 may include any type of conventional processor or microprocessor that interprets and executes programming instructions. Local memory 804 may include a random-access memory (RAM) or another type of dynamic storage device that stores information and instructions for execution by processor 802 and/or a read only memory (ROM) or another type of static storage device that stores static information and instructions for use by processor 802. Input interface 814 may comprise one or more conventional mechanisms that permit an operator or user to input information to the computing device 800, such as a keyboard 820, a mouse 830, a pen, voice recognition and/or biometric mechanisms, a camera, etc. Output interface 816 may comprise one or more conventional mechanisms that output information to the operator or user, such as a display 840, etc. Communication interface 812 may comprise any transceiver-like mechanism such as for example one or more Ethernet interfaces that enables computing system 800 to communicate with other devices and/or systems, for example with other computing devices 881, 882, 883. The communication interface 812 of computing system 800 may be connected to such another computing system by means of a local area network (LAN) or a wide area network (WAN) such as for example the internet. Storage element interface 806 may comprise a storage interface such as for example a Serial Advanced Technology Attachment (SATA) interface or a Small Computer System Interface (SCSI) for connecting bus 810 to one or more storage elements 808, such as one or more local disks, for example SATA disk drives, and control the reading and writing of data to and/or from these storage elements 808. Although the storage element(s) 808 above is/are described as a local disk, in general any other suitable computer-readable media such as a removable magnetic disk, optical storage media such as a CD or DVD, -ROM disk, solid state drives, flash memory cards, . . . could be used.

As used in this application, the term “circuitry” may refer to one or more or all of the following:
(a) hardware-only circuit implementations such as implementations in only analog and/or digital circuitry and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and/or processor(s), such as microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A computer-implemented method for processing image data representing at least one image, wherein said image data includes at least one input pixel array I(x,y,t), wherein a pixel value is associated to each pixel of the at least one input pixel array, the method comprising the steps of:
Recursively performing a hierarchal multiscale decomposition of the image data into a multilevel hierarchy of pixel arrays, wherein per scale level of the multilevel hierarchy, the at least one input pixel array is decomposed into a low frequency pixel array C_{LF}(x,y) and at least one high frequency pixel array C_{HF}^{k}(x,y);
Per scale level of the multilevel hierarchy of pixel arrays, forming a first cluster of pixel arrays of said scale level by selecting
either a plurality of said low frequency pixel arrays C_{LF}(x,y,t) of said scale level of the multilevel hierarchy of a temporal sequence of input pixel arrays I(x,y,t);
or the low frequency pixel array C_{LF}(x,y) and the at least one high frequency pixel array C_{HF}^{k}(x,y) of said scale level of the multilevel hierarchy of the at least one input pixel array;
Per scale level of the multilevel hierarchy, performing a first edge preserving convolution to the low frequency pixel array of said scale level of said multilevel hierarchy of pixel arrays using a weighted filtering wherein a weight of the filtering for a pixel is dependent on a distance between the pixel values associated to said pixel in each of the pixel arrays of said first cluster of pixel arrays of said scale level simultaneously; and
Recomposing an output pixel array by recursively performing an inverse transform of the hierarchal multiscale decomposition on the filtered low frequency pixel array and the high frequency pixel arrays.

2. The method according to claim 1, wherein said first cluster of pixel arrays is formed by selecting the plurality of said low frequency pixel arrays of said scale level of the multilevel hierarchy of said temporal sequence of input pixel arrays.

3. The method according to claim 2, wherein the weight w of the filtering for a pixel of said low frequency pixel array C_{LF}(x,y,t) of the temporal sequence of input pixel arrays at times t in a time window [tₘᵢₙ, tₘₐₓ] around a reference time t₀ is given by:
$$w ( x , y , t ) = exp ( - \frac{\vert {C}_{LF} ( x , y , t ) - {C}_{LF} ( x , y , {t}_{0} ) \vert}{2 {σ}_{t}^{2}} ) .$$
where σₜ is a parameter linked to flicker and/or noise amplitude.

4. The method according to claim 1, wherein said first cluster of pixel arrays is formed by selecting the low frequency pixel array and the at least one high frequency pixel array of said scale level of the multilevel hierarchy of the at least one input pixel array.

5. The method according to claim 1, wherein a weight of the filtering is further dependent on a distance between the pixel values associated to a pixel in a neighbourhood around said pixel.

6. The method according to claim 4, wherein the weight W of the filtering for a pixel of said low frequency pixel array C_{LF}(x,y) is dependent on the distance given by
$$D ( i , j ) = \sqrt{{( {C}_{LF} ( x + i , y + j ) - {C}_{LF} ( x , y ) )}^{2} + {\sum }_{k} {( {C}_{HF}^{k} ( x + i , y + j ) - {C}_{HF}^{k} ( x , y ) )}^{2}}$$
where k is the index of the high frequency pixel arrays of the scale level for which the filtering is performed and (x+i,y+j) indicates a neighbouring pixel around pixel (x,y).

7. The method according to claim 4, further comprising the step of, per scale level of the multilevel hierarchy, performing an edge preserving convolution to the at least one high frequency pixel array of said scale level of said multilevel hierarchy of pixel arrays using a weighted filtering wherein a weight of the filtering for a pixel is dependent on a distance between the pixel values associated to said pixel in each of the pixel arrays of said first cluster of pixel arrays of said scale level simultaneously.

8. The method according to claim 7, wherein the step of recomposing the output pixel array is done by recursively performing an inverse transform of the hierarchal multiscale decomposition on the filtered low frequency pixel array and the filtered high frequency pixel arrays.

9. The method according to claim 4, wherein the weight of the filtering includes at least one factor configured to adjust a weight of each of the low frequency pixel array and the at least one high frequency pixel array of the first cluster.

10. The method according to claim 4, further comprising a step of forming a second cluster of pixel arrays of said scale level by selecting said low frequency pixel arrays of said scale level of the multilevel hierarchy of a temporal sequence of input pixel arrays, and a step of performing a second edge preserving convolution step on the filtered low frequency pixel array.

11. The method according to claim 10, wherein the step of performing the first edge preserving convolution is performed to the low frequency pixel array and to the at least one high frequency pixel array of said scale level of said multilevel hierarchy of pixel arrays, and wherein the step of performing the second edge preserving convolution on the filtered low frequency pixel array of said scale level of said multilevel hierarchy of pixel arrays is performed using a weighted filtering wherein a weight of the filtering for a pixel is dependent on a distance between the pixel values associated to said pixel in each of the pixel arrays of said second cluster of pixel arrays of said scale level simultaneously, and wherein the step of recomposing the output pixel array is done by recursively performing an inverse transform of the hierarchal multiscale decomposition on the low frequency pixel array filtered by the second edge preserving convolution and the high frequency pixel arrays filtered by the first edge preserving convolution.

12. A controller comprising at least one processor and at least one memory including computer program code, the at least one memory and computer program code configured to, with the at least one processor, cause the controller to perform a method according to claim 1.

13. A computer program product comprising computer-executable instructions for performing the method according to claim 1, when the program is run on a computer.

14. A computer readable storage medium comprising computer-executable instructions for performing the method according to claim 1, when the program is run on a computer.
